(19) United States
(12) Patent Application Publication
(10) Pub. No.: US 2013/0196033 A1
(43) Pub. Date: Aug. 1, 2013

(54) Crisp Bread Snack Foods

(71) Applicants: Ashish ANAND, Plano, TX (US); Heidi KLEINBACH-SAUTER, Manakin-Sabot, VA (US); Vamshidhar PUPPALA, McKinney, TX (US); Pramila SRIVASTAVA, Allen, TX (US); Ngoc TRINH, Dallas, TX (US)

(72) Inventors: Ashish ANAND, Plano, TX (US); Heidi KLEINBACH-SAUTER, Manakin-Sabot, VA (US); Vamshidhar PUPPALA, McKinney, TX (US); Pramila SRIVASTAVA, Allen, TX (US); Ngoc TRINH, Dallas, TX (US)

(73) Assignee: FRITO-LAY NORTH AMERICA, INC., Plano, TX (US)

(21) Appl. No.: 13/363,809

(22) Filed: Feb. 1, 2012

(51) Int. Cl. A21D 13/06; A21D 2/08; A21D 13/04; A21D 8/02

(52) U.S. Cl. 426/94; 426/559; 426/558; 426/446; 426/19; 426/298; 426/296

(57) ABSTRACT

Crisp bread snack food products based on traditional bread recipes from around the world and a method for producing the products on a commercial processing line. The crisp bread snack food products are shelf-stable and have flavors substantially similar to the traditional breads.

### BACKGROUND OF THE INVENTION

1. Technical Field

The present invention relates to shelf-stable crisp bread snack food products based on traditional bread recipes from around the world.

2. Description of Related Art

Bread is a staple in the diet of essentially every culture. Each culture or region has its own traditional recipes. Some examples are Swedish oat bread from Sweden, Torta bread from Spain and Challah bread from the Middle East. Traditional breads typically have a significant moisture content, which limits their shelf-life. The production of traditional breads involves significant preparation time and baking time. Because of the limited shelf-life and time involved in preparing the breads, traditional breads are not preferred as a snack food product. Consequently, it would be desirable to adapt the traditional bread recipes for production on a commercial processing line to produce a variety of shelf-stable snack food products that have substantially similar flavors to the traditional breads.

### SUMMARY OF THE INVENTION

The present invention is directed to crisp bread snack food products. Traditional bread recipes from around the world have been modified and adapted to a commercial processing line to produce shelf-stable snack foods with flavors substantially similar to the traditional breads but with a prolonged shelf life. The crisp bread products contains about 15% to 75% of cereal flour, about 5% to 25% starches or starch-rich ingredients, about 0.5% to 15% proteins, about 0.5% to 5% flavoring ingredients, about 0.5% to 5% leavening agents, about 0.3% to 3% salt, about 2% to 15% sugar, about 2% to 25% fat ingredients, and about 0.5% to 5% fibers. The crisp bread products are produced by mixing the dry ingredients, activating the yeast if necessary, mixing in the liquid ingredients thoroughly to achieve a sheetable dough, sheeting the dough, cutting the dough into the desired shape, baking the dough pieces for a predetermined length of time at a predetermined temperature, and drying the baked dough pieces to reduce the moisture content of the crisp bread products to an acceptable amount. The finished crisp bread products of the present invention have a moisture content of about 1-8%, preferably about 1.5-3.5%, and a thickness of about 2-14 millimeters.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart depicting an embodiment of the method of the invention.

FIGS. 2-7 are RVA profiles of the doughs of several embodiments of the invention.

FIG. 8 is a RVA profile of typical saltine cracker dough.

FIG. 9 is a RVA profile of typical bread dough.

FIG. 10 is a graph comparing the flow behavior of the doughs of several embodiments of the invention.

FIG. 11 is a graph comparing the apparent viscosity of the doughs of several embodiments of the invention.

FIGS. 12-17 are graphs showing the storage and loss modulus and complex viscosity of the doughs of several embodiments of the invention.

FIG. 18 is a graph showing the storage and loss modulus and complex viscosity of typical saltine cracker dough.

FIG. 19 is a graph showing the storage and loss modulus and complex viscosity of typical bread dough.

### DETAILED DESCRIPTION OF THE INVENTION

Several embodiments of Applicants' invention will now be described with reference to the drawings. Unless otherwise noted, like elements will be identified by identical numbers throughout all figures. The invention illustratively disclosed herein suitably may be practiced in the absence of any element which is not specifically disclosed herein.

The invention described herein is directed to crisp bread snack food products. Traditional bread recipes from around the world have been modified and adapted to a commercial processing line to produce shelf-stable snack foods with flavors substantially similar to the traditional breads but with a prolonged shelf life.

An embodiment of the invention will now be described. In modifying the traditional bread recipes for a shelf-stable snack food produced by a commercial processing line, key classes of ingredients were found to be necessary to compensate for the lack of appropriate conditions such as moisture, preparation time, baking time and temperatures used to prepare traditional breads. One such class of key ingredients is pregelatinized and native starches. Pregelantinized and/or native starches enhance the cohesiveness of the dough for sheeting and the integrity of the raw cut dough pieces, lower breakage in finished product and provide a crisp texture in the finished product. Use of pregelatinized starches in particular enables development of desirable texture even under insufficient conditions of temperature and time that are typical of commercial baking processes. Another class of key ingredients is network-forming proteins, which enhance the sheeting performance of the dough by improving cohesion and structural strength and reduce breakage in the finished product. An added benefit of using such proteins is the improved nutritional quality of the finished product by increasing the protein content.

Though each crisp bread snack food product has a unique formulation, all of the formulations contain the same classes of ingredients. In a preferred embodiment, a crisp bread product contains about 15% to 75% of cereal flour, about 5% to 25% starches or starch-rich ingredients, about 0.5% to 15% proteins, about 0.5% to 5% flavoring ingredients, about 0.5% to 5% leavening agents, about 0.3% to 3% salt, about 2% to 15% sugar, about 2% to 25% fat ingredients, and about 0.5% to 5% fibers. In one embodiment, the cereal flour used is wheat flour, tapioca flour, rice flour, or rye flour but it may be any other cereal flour. In one embodiment, corn or tapioca flour is used to supply a precooked high-amylopectin starch, but any precooked or raw cereal starch or flour may be used. In one embodiment of the invention, vital wheat gluten is used for the protein but whole egg, egg yolk, milk powder, soy protein, egg protein or cereal protein may also be used. The leavening agents used may be compressed yeast, dry active yeast, instant dry active yeast, baking soda or baking powder. The fat ingredients used may be butter, margarine, vegetable oils, olive oil or canola oil, and the fibers used may be oat fiber, any vegetable fiber or any cereal grain. To optimize the flavor of the crisp bread products, different flavoring ingredients may be included. Examples of possible flavoring ingredients are aromatic herbs such as rosemary, thyme, basil, oregano, marjoram, sage and cilantro, spices such as garlic, ginger, cumin and pepper, extracts such as almond, anise, citrus and hazelnut, and fruit or vegetable inclusions such as red peppers, green peppers, tomato and eggplant. A topping or surface treatment of egg wash, nuts, seeds, sugar or dried fruits may optionally be applied to the crisp bread product to further enhance the flavor.

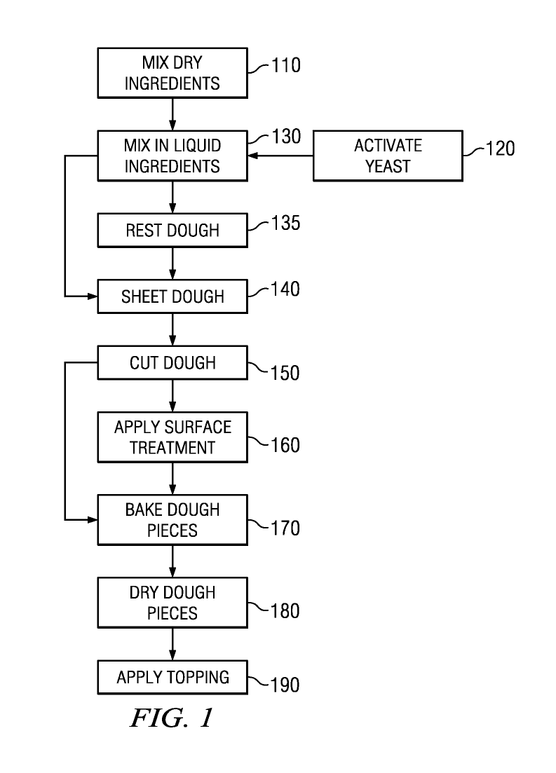

While the method of preparing each crisp bread product employs processing steps and conditions specific to the particular formulation, the overall process for producing a crisp bread snack product includes essentially the same operations. As outlined in FIG. 1, the process for producing the crisp bread products involves mixing the dry ingredients 110, activating the yeast 120 if necessary, and mixing in the liquid ingredients 130 thoroughly to achieve a sheetable dough. The ingredients are mixed for a total time of about 2-10 minutes. The dough is then rested 135 for up to an hour, if necessary, to allow the dough to rise. Next the dough is sheeted 140 to a thickness of about 1.5-2.5 millimeters and cut 150 into the desired shape. A surface treatment may optionally be applied 160 after the dough is cut into pieces. The dough pieces are then baked 170 for about 1-6 minutes at a temperature of about 330-800° F. During baking, the air velocity in the oven is about 2-7 m/s, the heat flux of the oven is about 2-18 Kw/m², and the overall heat transfer coefficient is about 3-7 BTU/(hr)(ft²)(° F.). The crisp bread products exit the oven with a moisture content of about 6-25% by weight. The baked dough pieces are dried 180 for about 10-25 minutes at a temperature of about 300-400° F. to reduce the moisture content of the crisp bread products to an acceptable amount. An optional step is applying a topping 190 to the finished product.

In one embodiment, the baking step 170 is performed in an oven that combines the features of a convection oven, high velocity impingement oven and radiation oven. The convection capability of the oven provides expansion of the structure of the dough pieces during baking by rapidly injecting heat into the dough, thus vaporizing the water within the dough. The rapid heat transfer creates small micro blisters and pockets within the product. The high velocity impingement capability of the oven provides fast heat transfer which can cause rapid structural expansion in the raw dough piece resulting in desirable crispy textures. The radiation capability within the oven enhances the surface texture development of the product and product color. Combining these heat transfer capabilities in one oven allows creation of product textures and surface colors/appearances that cannot be obtained in an oven with a single mode of transfer.

The baking operation serves to develop textures and flavors within a product by cooking the dough through application of heat and also simultaneously removes about 80% of moisture from the dough. Drying operations further reduce the moisture content of the product to acceptable levels by removing the last about 18%, resulting in a shelf-stable product with a moisture content of about 2% by weight and a crispy texture. In the production of crackers and biscuits, most operations perform the baking and drying steps in the same oven. However, baking and drying in the same oven can lead to lower operational flexibility and limitation of the development of product texture, color and, removal of moisture. To avoid these issues, the present invention uses a single pass high velocity and temperature oven and a three pass low velocity and temperature dryer. Separating the baking and drying processes provides better control of the finished product and improved product quality.

The finished crisp bread products of the present invention have a moisture content of about 1-8% by weight, preferably about 1.5-3.5% by weight, and a thickness of about 2-14 millimeters.

### EXAMPLES

The examples described herein can be produced using a batch or continuous process.

### Example 1

### Swedish Crisp Bread

One example of a crisp bread snack food product is Swedish bread. The Swedish crisp bread is composed of, in percentage by weight of dough, about 25-35% all-purpose flour, about 20-30% baby oats, about 10-20% margarine, about 3-6% sugar, about 1.5-2.5% vital gluten, about 0.5-1% baking soda, about 0.5-1.5% salt, about 3-6% dried milk powder, and about 10-15% water. The dough is prepared by first mixing the margarine and sugar at a fast speed for about 10 minutes, adding in the remaining dry ingredients and mixing at a slow speed for about 2 minutes and then adding in the water and mixing for about 10 minutes at a slow speed. The dough is then sheeted to a thickness of about 1.5-2.5 millimeters and cut into pieces by a rotary cutter. The weight of five pieces of cut Swedish dough (of 2 inch diameter) is about 35 grams. The cut dough pieces are then conveyed to an oven for baking Prior to entering the oven, the dough pieces have a moisture content of about 21-23% by weight. After baking in the oven for about 3 minutes at about 375-400° F., the pieces exit the oven with a moisture content of about 5-8% by weight. The pieces are dried in a multi-pass dryer at a temperature of about 300-305° F. for about 10-15 minutes. The finished Swedish crisp bread snack products have a moisture content of about 1.5-3% by weight.

### Example 2

### Challah Crisp Bread

Another example of a crisp bread snack food product is Challah bread. The Challah crisp bread is composed of, in percentage by weight of dough, about 20-30% all-purpose flour, about 5-15% cake flour, about 3-10% tapioca flour, about 5-10% corn starch, about 1-2% dry active yeast, about 1-4% non-fat dried milk powder, about 1-3% baking powder, about 3-8% whole liquid egg, about 5-10% salt, about 5-10% sugar, about 2-6% honey, about 1-2% dried egg yolk, about 5-15% margarine and about 9-13% water. The yeast is activated by adding the yeast to the water, which is heated to a temperature of about 100-110° F., with about 5% sugar by weight of the solution. The dough is prepared by first mixing all of the dry ingredients, except for the yeast, at a fast speed for about 2 minutes. Next the margarine, softened and at a temperature of 60-85° F., whole liquid eggs, honey and water with activated yeast is added and mixed for about 8 minutes at a slow speed and then for about 1 minute at a fast speed. After mixing, the dough can be rested up to about 60 minutes.

After the dough rests, it is sheeted to a thickness of about 1.5-2.5 millimeters and cut into pieces by a rotary cutter. The weight of five pieces of cut Challah dough (of 2 inch diameter) is about 34 grams. The cut dough pieces are sprayed with a mixture of 1 part egg yolk powder, 2 parts non-fat milk powder, and 4 parts water and then conveyed to an oven for baking Before baking, the dough pieces have a moisture content of about 25-28% by weight. After baking in the oven for about 3 minutes at about 375-420° F., the pieces exit the oven with a moisture content of about 10-15% by weight. The pieces are dried in a multi-pass dryer at a temperature of about 280-285° F. for about 10-25 minutes. The finished Challah crisp bread snack products have a moisture content of about 1.5-3.0% by weight.

### Example 3

### Torta Crisp Bread

Another example of a crisp bread snack food product is Torta bread. The Torta crisp bread is composed of, in percentage by weight of dough, about 30-40% all-purpose flour, about 5-10% tapioca flour, about 10-20% corn starch, about 1.5-2.5% dry active yeast, about 1-2% non-fat dried milk powder, about 1-3% baking powder, about 3-5% whole liquid egg, about 0.5-1% salt, about 3-8% sugar, about 10-16% olive oil, about 0.3-0.8% anise seeds, about 0.3-0.6% almond extract, about 2-4% margarine and about 18.5% water. The yeast is activated by adding the yeast to the water, which is heated to a temperature of about 100-110° F., with 5% sugar by weight of the solution. The dough is prepared by first mixing all of the dry ingredients, except for the yeast, at a fast speed for about 2 minutes. Next the olive oil, whole liquid eggs, and water with activated yeast is added and mixed for about 6 minutes at a slow speed and then for about 1 minute at a fast speed. After mixing, the dough can be rested up to about 60 minutes.

After the dough rests, it is sheeted to a thickness of about 1.5-2.5 millimeters and cut into pieces by a rotary cutter. The weight of five pieces of cut Torta dough (of 2 inch diameter) is about 27 grams. The cut dough pieces are then conveyed to an oven for baking. Before baking, the dough pieces have a moisture content of about 27-30% by weight. After baking in the oven for about 3-4 minutes at 390-395° F., the pieces exit the oven with a moisture content of about 10-11% by weight. The pieces are dried in a multi-pass dryer at a temperature of about 290-295° F. for about 10-25 minutes. The finished Torta crisp bread snack products have a moisture content of about 2-3% by weight.

Characterization

The crisp bread doughs of several embodiments of the present invention, including the above-described examples, were characterized to determine their starch pasting behavior and rheology. First, the starch pasting behavior of the doughs were determined with a Rapid Visco Analyzer (hereinafter “RVA”) (Newport Scientific). Dough suspensions with 12% solids were subjected to 50° C. for five minutes, a ramp up to 95° C. over three minutes, 95° C. for three minutes, and a ramp down to 50° C. over seven minutes at a shear rate of 960 rpm for the first fourteen seconds and then 160 rpm for the remainder of the test. All crisp bread formulations exhibit RVA profiles typical of those rich in native or raw starch, but have a range of distinct peak, trough and final viscosities. As used herein, peak viscosity is a function of the amount and chemical state, i.e., raw or pregelatinized, of the starch in the formulation. Peak viscosity is developed progressively as the starch hydrates and swells as it is cooked or gelatinized. As used herein, trough viscosity is the lowest value in the viscosity curve occurring after the peak viscosity is developed, and is a function of the effect of shear on the gelatinized starch. The difference between the peak and trough viscosities, known as the breakdown value, quantifies the relative tolerance to shear, or shear thinning behavior, of different formulations. As used herein, final viscosity is the viscosity achieved at the end of the test and is a function of the amount and chemical state, i.e., raw or pregelatinized, of the starch in the formulation. The difference between the final and trough viscosities, known as the setback value, quantifies the relative degree of starch retrogradation in the different formulations.

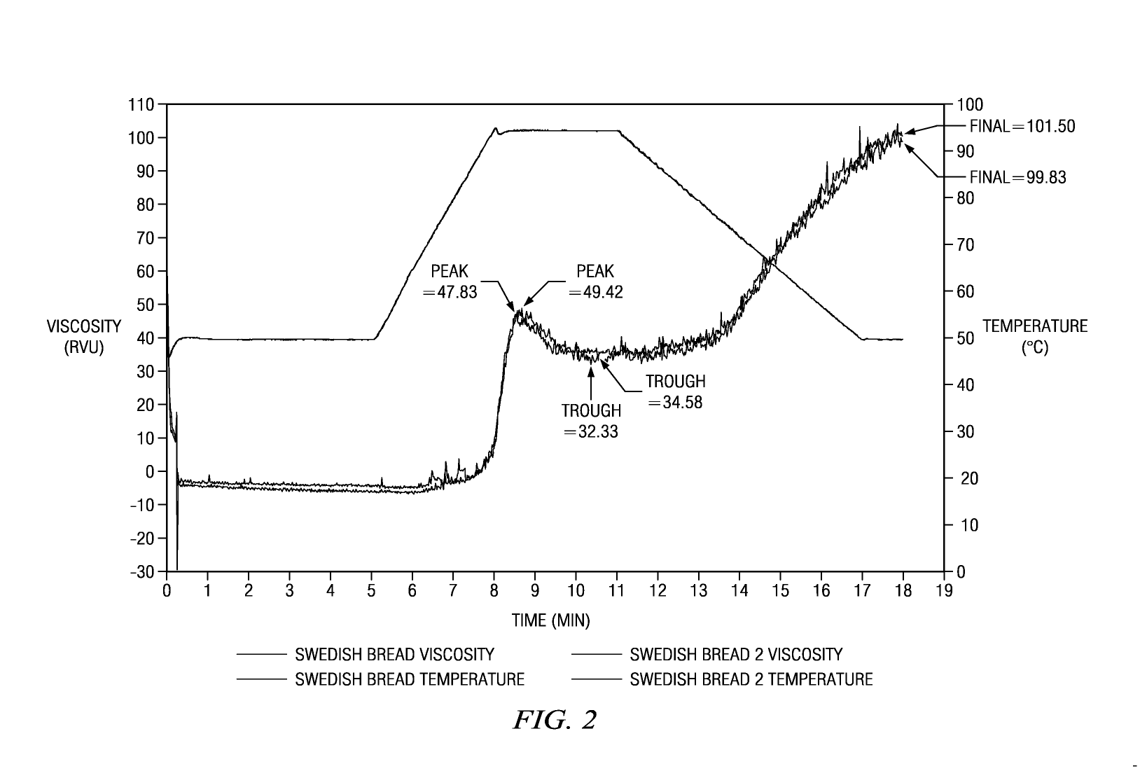

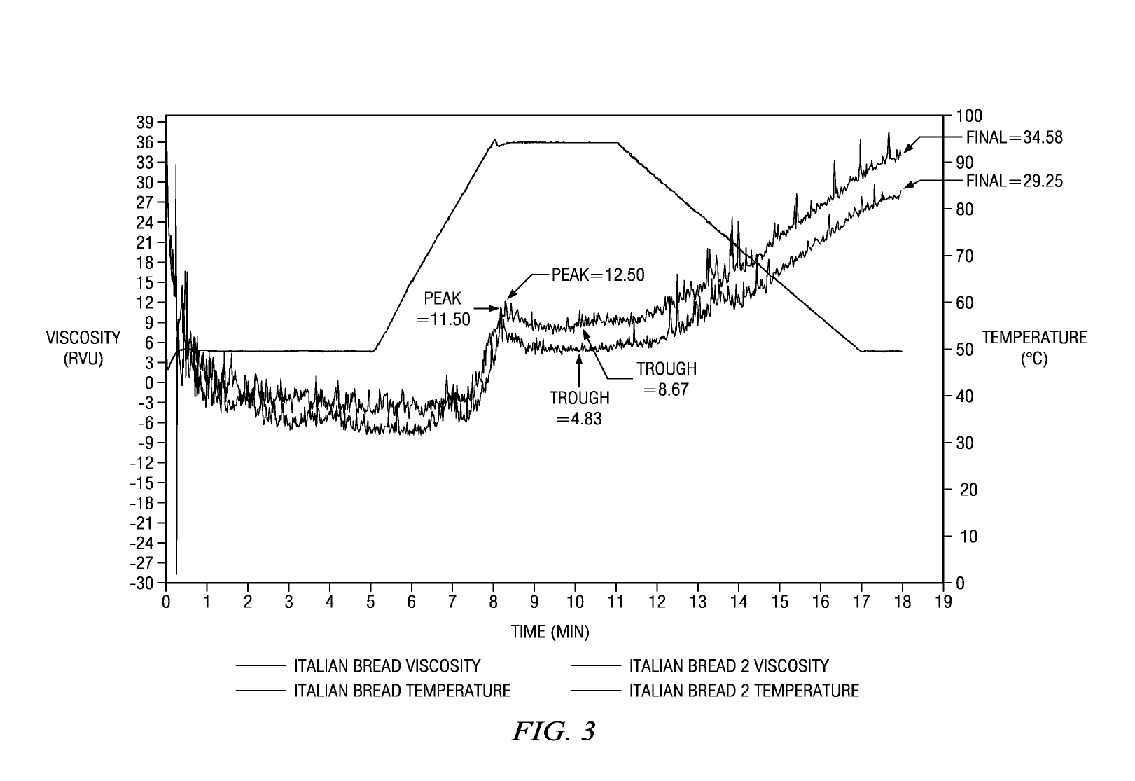

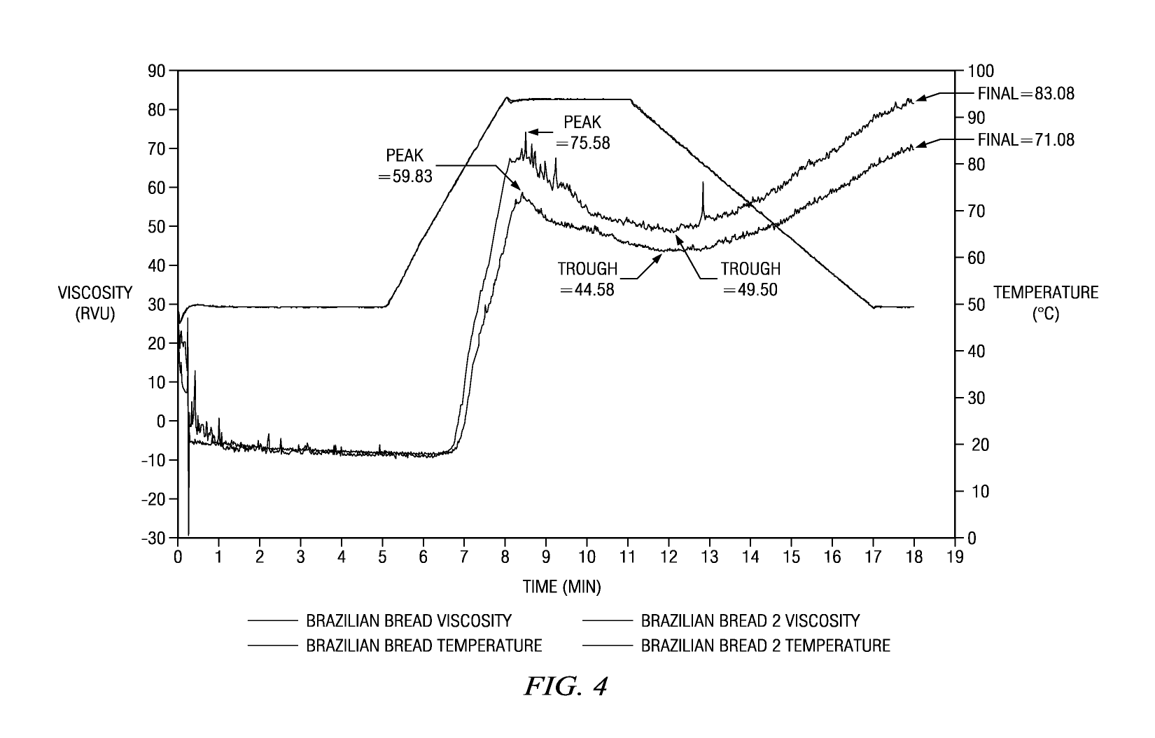

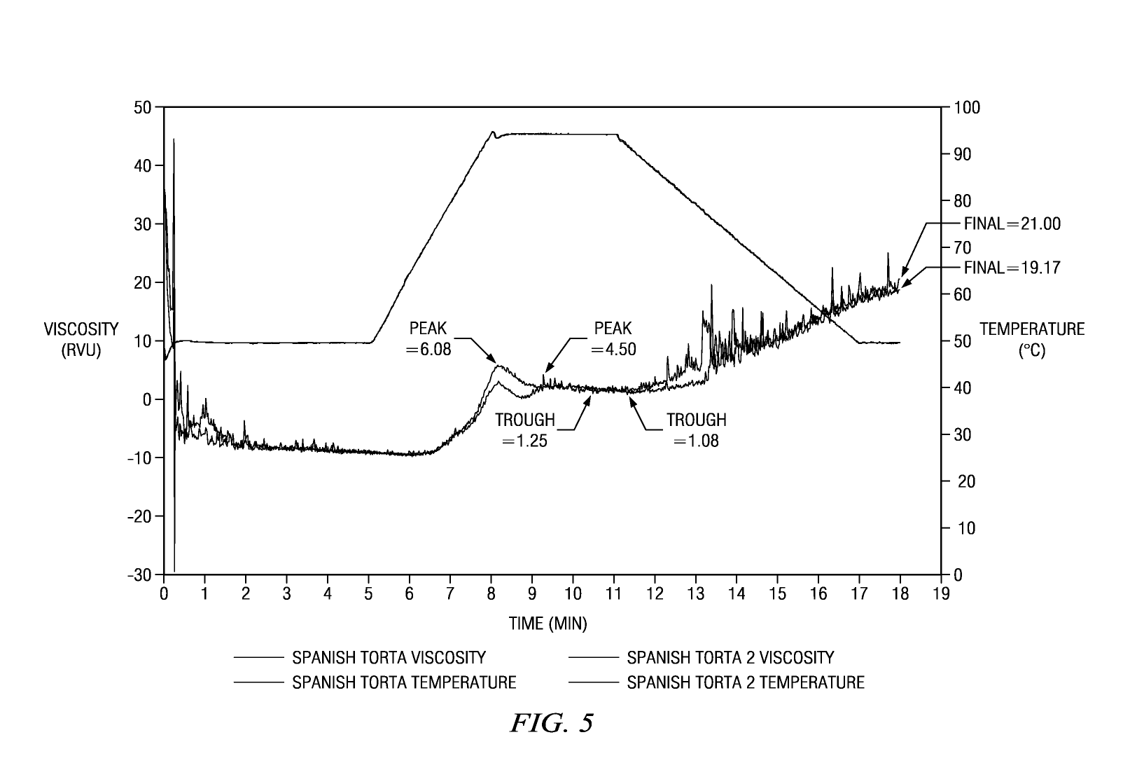

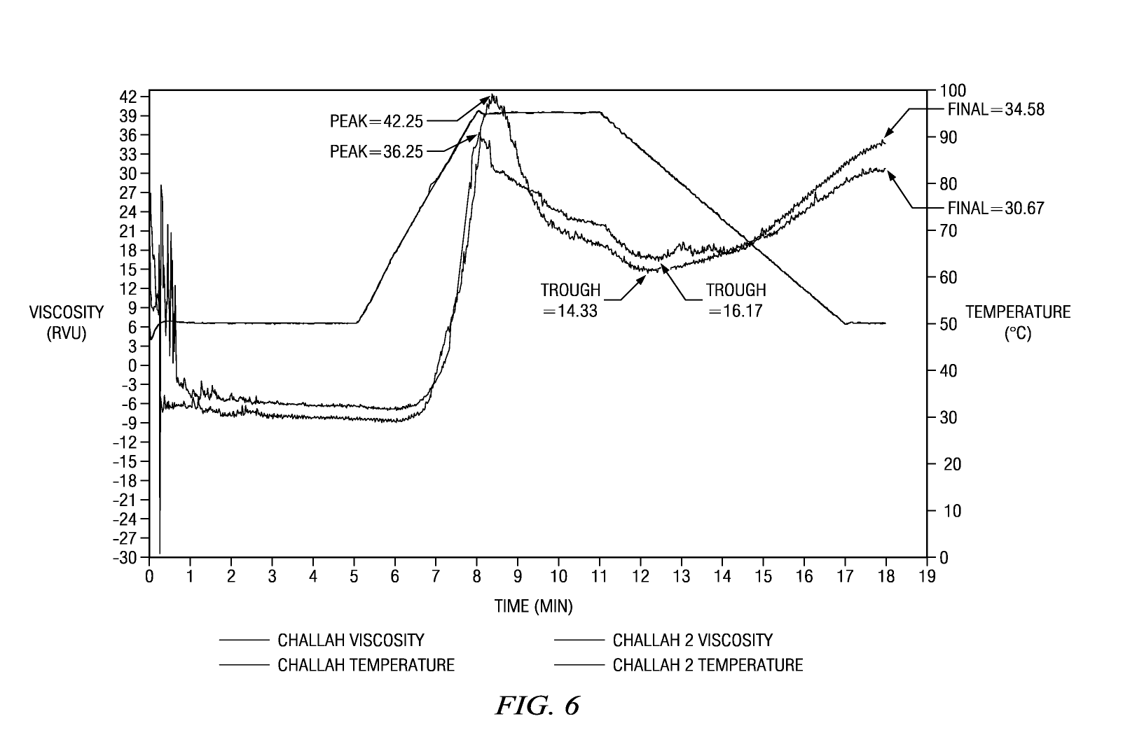

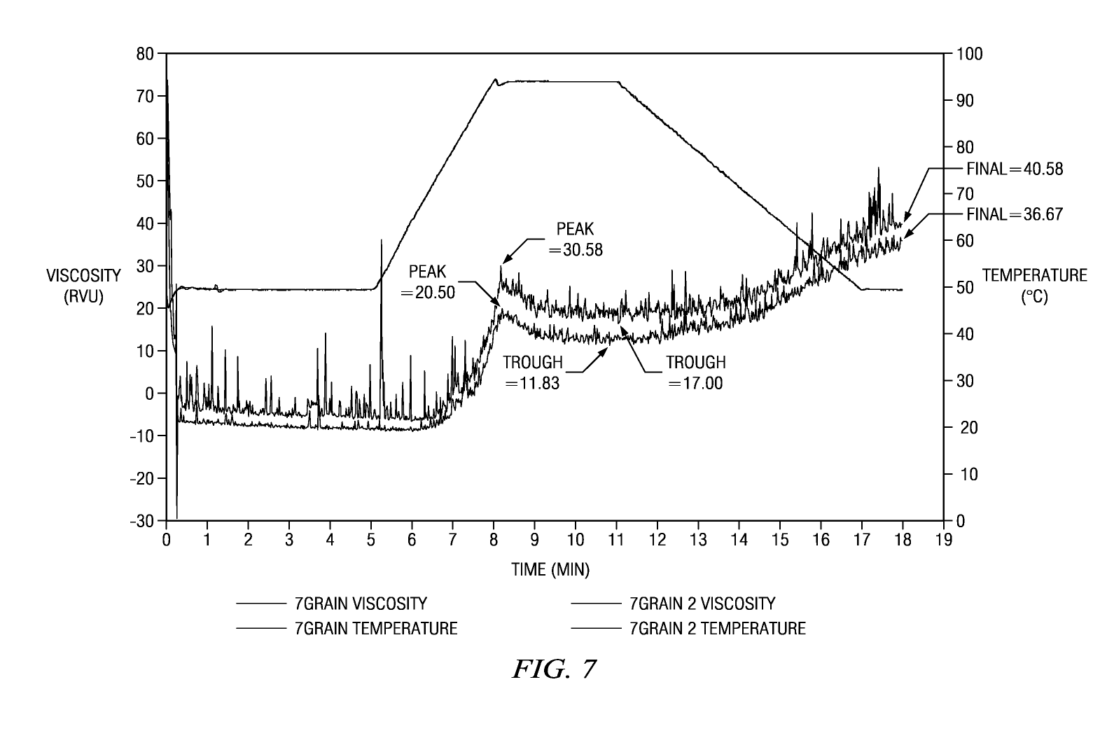

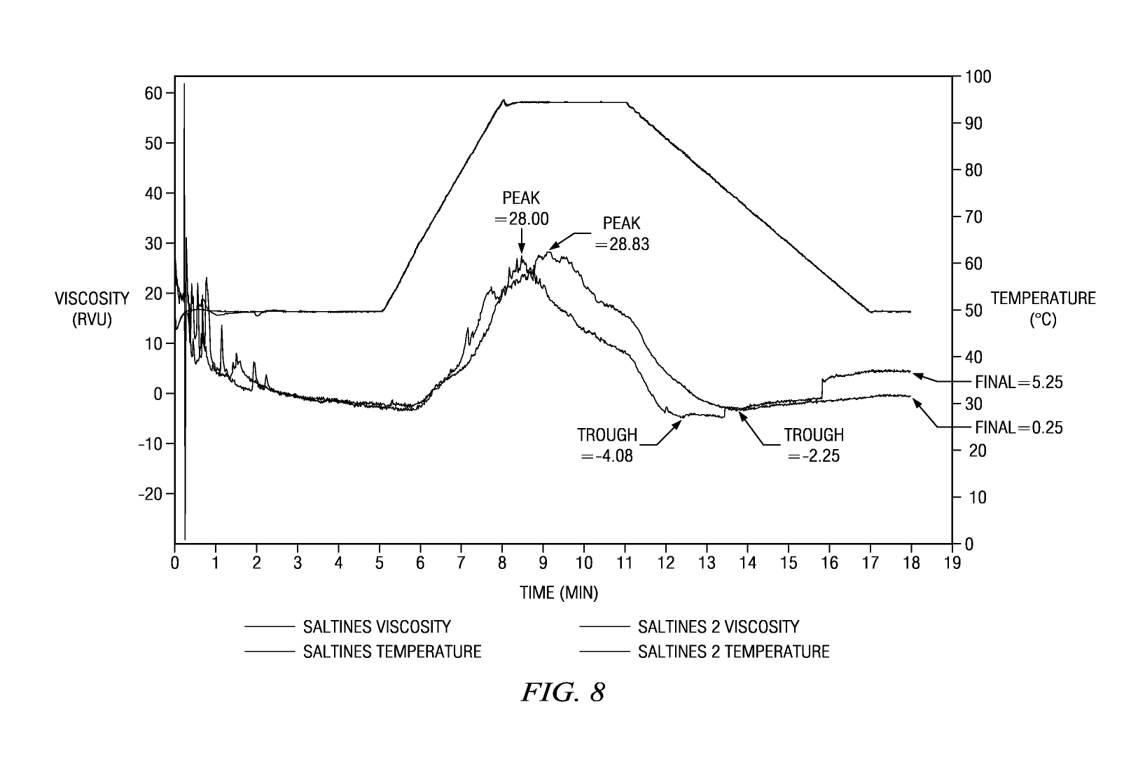

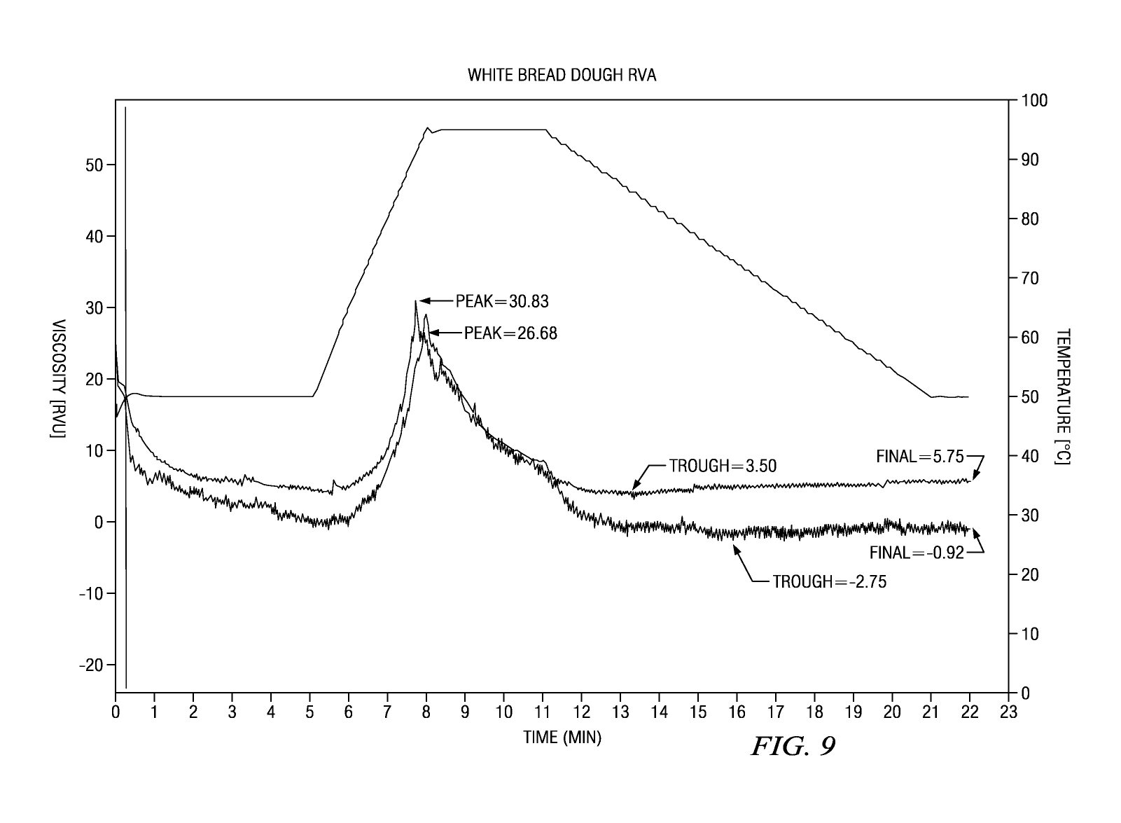

The crisp bread doughs exhibit a wide range of starch pasting behavior dependent upon the level and nature of starch and other ingredients that can affect starch behavior in response to thermal and shear treatments. Overall, the crisp bread doughs exhibit peak viscosities ranging from about 60 to 800 centipoise, breakdown values from about 50 to 400 centipoise and setback values from about 14 to 300 centipoise. The RVA profiles for each of crisp bread formulations disclosed in the Examples are shown in FIGS. 2-7. The RVA profiles for typical saltine crackers and typical bread dough are shown in FIGS. 8 and 9, respectively, for comparison purposes. The relevant data points are summarized in Table 1.

TABLE 1
RVA viscosities of the crisp bread products described in the Examples
and typical cracker and bread formulas for comparison.

| | Average RVA Viscosities (centipoise), (n = 2) | | | | |
|---|---|---|---|---|---|
| | Peak | Trough | Final | Breakdown | Setback |
| Spanish Torta | 63 | 14 | 241 | 50 | 227 |
| Italian Bread | 144 | 81 | 383 | 63 | 302 |
| 7-Grain | 306 | 173 | 464 | 134 | 291 |
| Challah | 471 | 183 | 392 | 288 | 209 |
| Swedish Bread | 584 | 401 | 1208 | 182 | 807 |
| Brazilian Bread | 812 | 564 | 925 | 248 | 360 |
| Crackers | 341 | 0 | 33 | 341 | 33 |
| Bread | 344 | 21 | 34.5 | 323 | 14 |

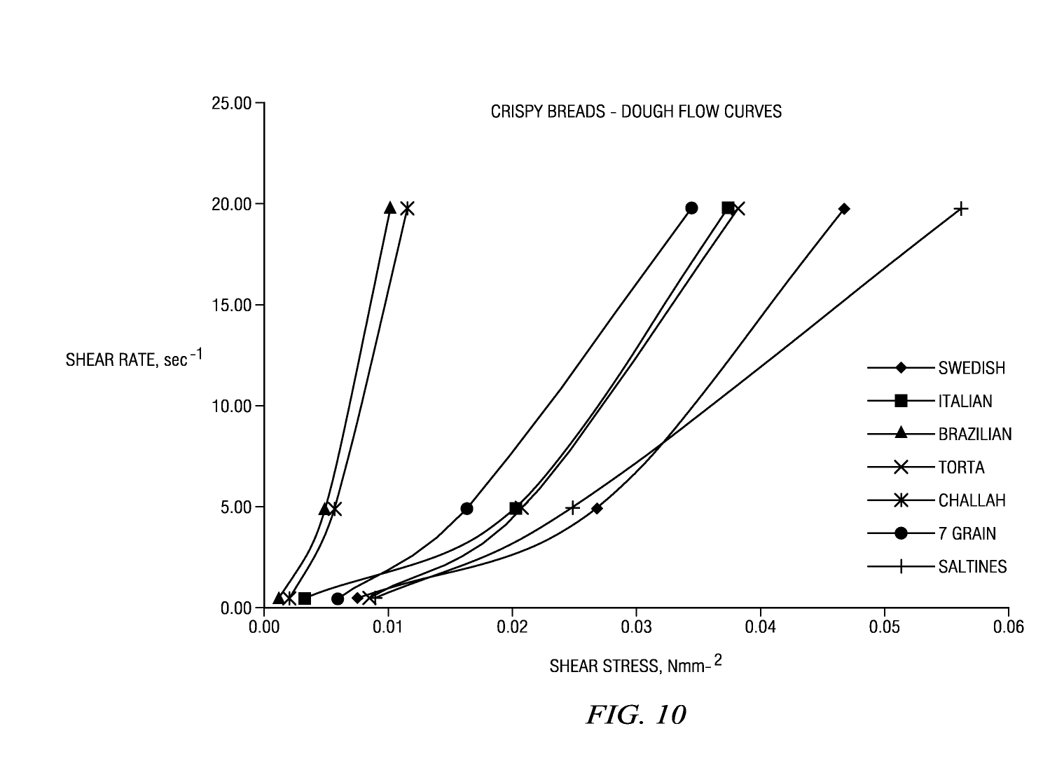

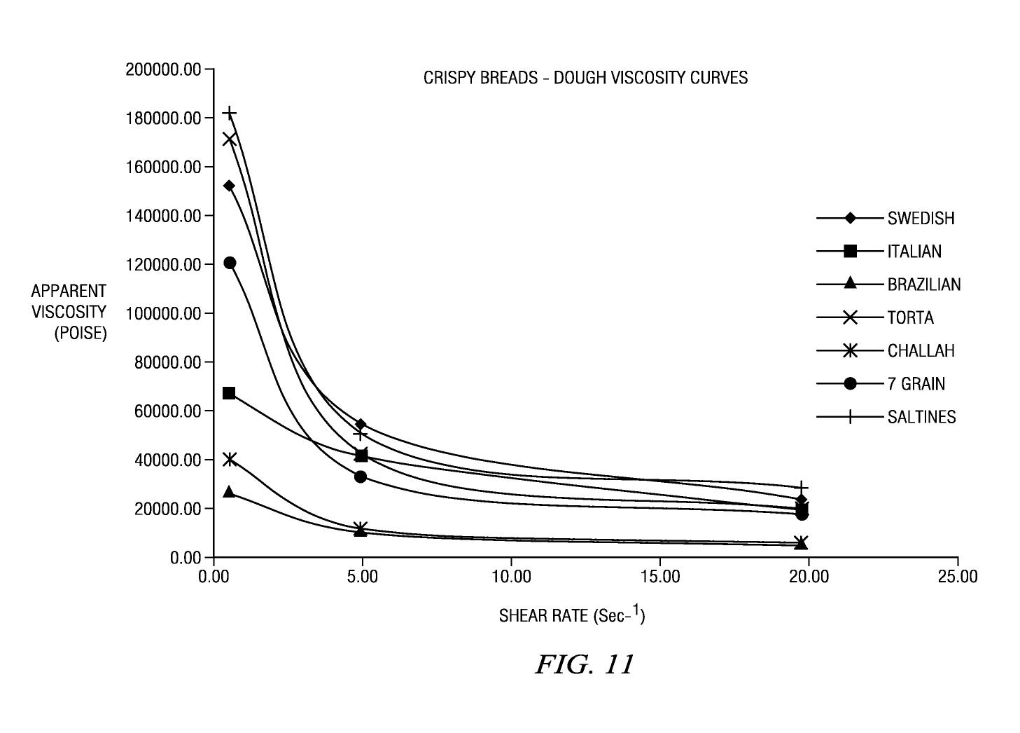

The flow behavior and apparent viscosity of the crisp bread doughs disclosed in the Examples were characterized by a simple extrusion test, where doughs were extruded through an orifice of known dimension at shear rates of 0.49 sec⁻¹, 4.94 sec⁻¹ and 19.74 sec⁻¹. Flow curves were constructed and the shear stress and apparent viscosity were determined based on the measured response to the applied shear rates. All of the crisp bread dough formulations exhibit non-Newtonian shear thinning behavior while differing in the degree of their shear tolerance, as depicted in FIG. 10. The apparent viscosity of the doughs decreased progressively with increasing shear rate, as shown in FIG. 11, ranging from 26, 536 Pascal sec to 170,785 Pascal sec at a shear rate 0.49 sec⁻¹, 10,056 Pascal sec to 54,245 Pascal sec at a shear rate of 4.94 sec⁻¹ and 5,127 Pascal sec to 23,639 Pascal sec at a shear rate 19.74 sec⁻¹. The relevant data is summarized in Table 2.

TABLE 2
Apparent viscosities of the crisp bread products described
in the Examples and typical cracker formula for comparison.

| | Apparent Viscosity | | | | | | |
|---|---|---|---|---|---|---|---|
| | (Pascal sec) | | | | | | |
| | | | | | | | Typical |
| Shear | | | | | | | cracker |
| Rate (s⁻¹) | Swedish | Italian | Brazilian | Torta | Challah | Mulitgrain | formula |
| 0.49 | 151558 | 66682 | 26536 | 170785 | 40146 | 120275 | 181395 |
| 4.94 | 54245 | 41001 | 10056 | 42057 | 11480 | 32920 | 50289 |
| 19.74 | 23639 | 18882 | 5127 | 19345 | 5837 | 17398 | 28405 |

The crisp bread doughs were also tested using the Amplitude Sweep: Linear-Visco-Elastic Range and Structural Strength, which is an oscillatory test performed at variable amplitudes while the frequency is kept at a constant value, to further characterize their viscoelastic behavior. The complex viscosity, storage modulus and loss modulus were determined for the crisp bread doughs as well as for cracker and typical bread dough for comparison purposes. The storage modulus, known as G′, is a measure of the deformation energy stored by the samples during the shear process and represents the elastic behavior of the dough. The loss modulus, known as G″, is a measure of the deformation energy used up by the sample during the shear process and represents the viscous behavior of the dough. The loss factor is the ratio of the viscous portion (G″) and the elastic portion (G′) of the viscoelastic deformation behavior. For a viscoelastic fluid, the loss modulus (G″) is greater than the storage modulus (G′). For a viscoelastic solid, the storage modulus (G′) is greater than the loss modulus (G″).

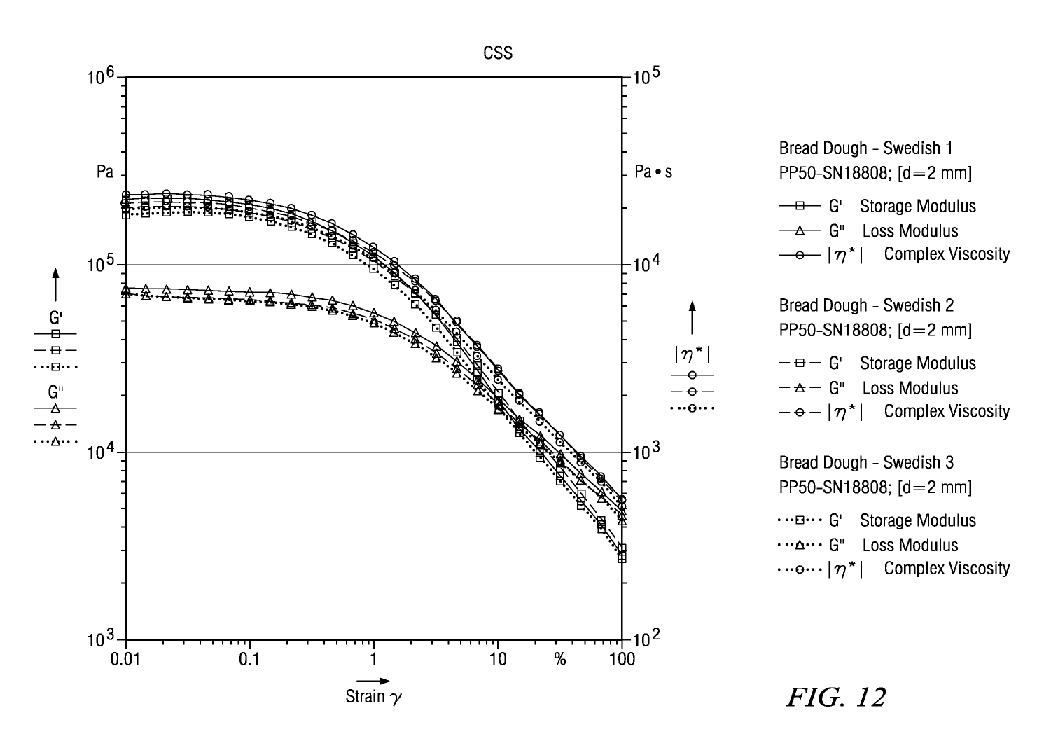

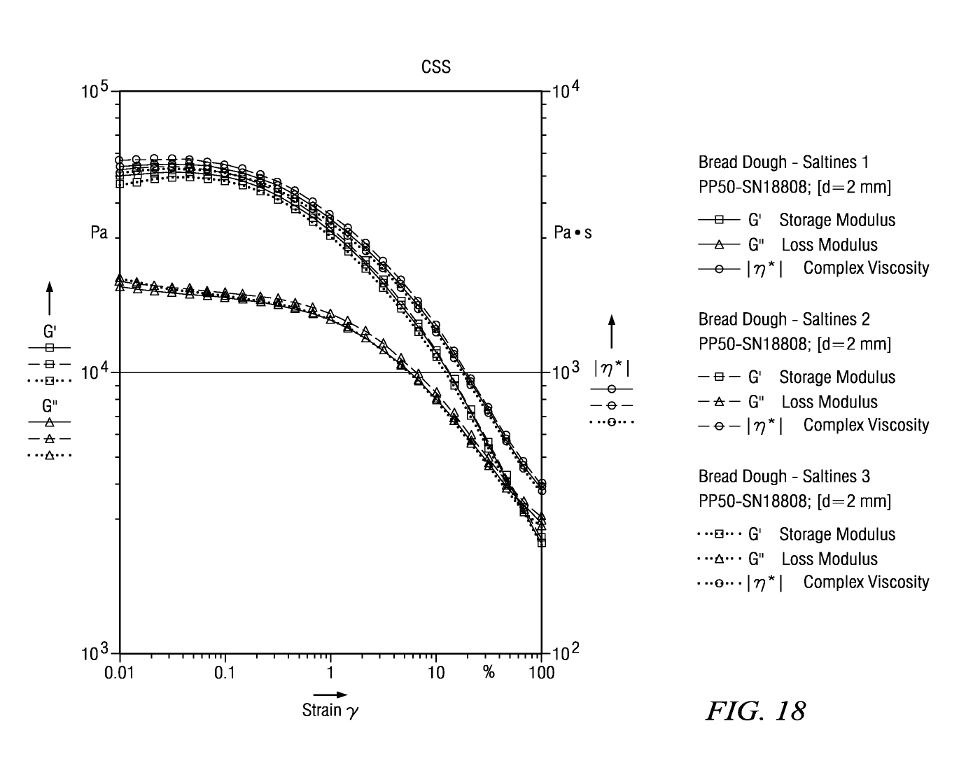

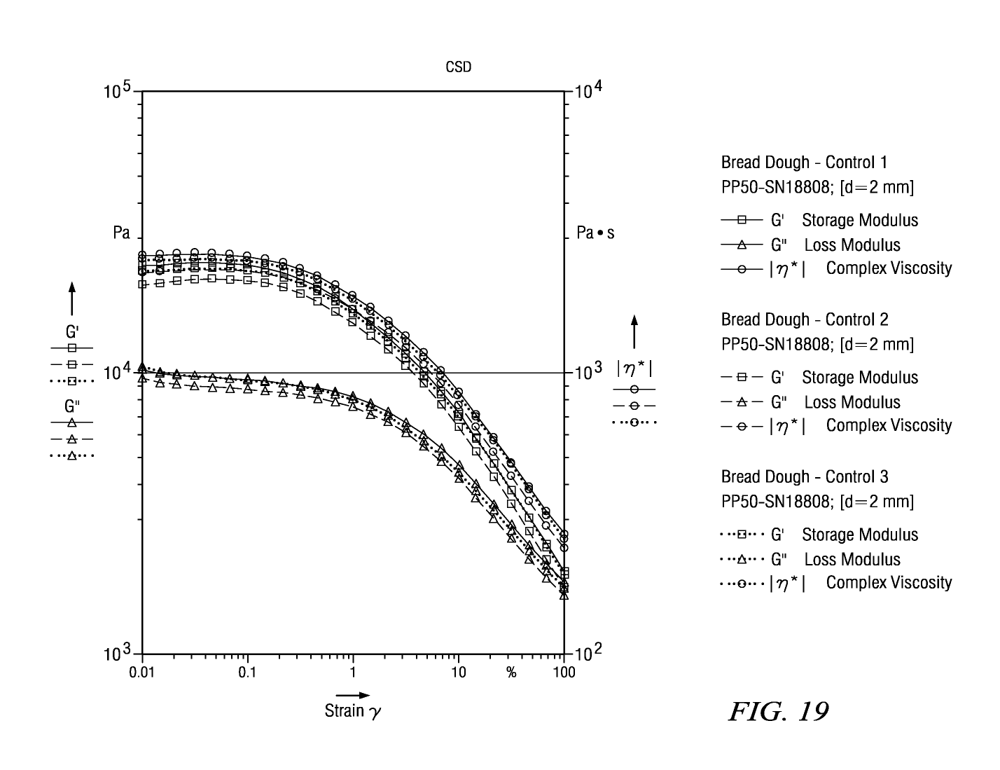

The plots of the data obtained for each of the Example crisp bread formulations are shown in FIGS. 12-17. The plots for typical cracker dough and bread dough are shown in FIGS. 18 and 19, respectively. The data summary is presented in Table 3.

TABLE 3
Results of the Linear-Visco-Elastic Range and Structural Strength
test for the crisp bread products described in the Examples.

| | Complex | | |
|---|---|---|---|
| | Viscosity at | Storage Modulus | Loss Modulus |
| Product | 25° C. (Pa/sec) | G′ (Pa) | G″ (Pa) |
| Swedish | 19000-23400 | 1.8-2.2 × 10⁵ | 6.9-7.5 × 10⁴ |
| Italian | 900-1000 | 8.0-9.0 × 10³ | 4.0-5.0 × 10³ |
| Brazilian | 500-700 | 4.9-6.1 × 10³ | 2.5-3.2 × 10³ |
| Torta | 1800-2500 | 1.5-2.2 × 10⁴ | 0.8-1.2 × 10⁴ |
| Challah | 800-1100 | 7.0-10.0 × 10³ | 3.5-5.0 × 10³ |
| Multigrain | 5500-7500 | 4.0-7.0 × 10⁴ | 2.5-3.5 × 10⁴ |
| Cracker | 5000-6000 | 4.5-5.2 × 10⁴ | 2.0-2.2 × 10⁴ |
| dough | | | |
| Loaf bread | 2200-2700 | 2.0-2.4 × 10⁴ | 0.9-1.05 × 10⁵ |
| dough | | | |

As can be seen in FIG. 12, in the Swedish crisp bread dough, the storage modulus (G′) is greater than the loss modulus (G″) until 10% strain is reached, meaning that the Swedish crisp bread dough demonstrates more elastic behavior for lower values of strain. However, at high values of strain, the Swedish dough has more viscous properties as the loss modulus (G″) is greater than the storage modulus (G′). The yield point of the Swedish crisp bread dough is at approximately 7% strain.

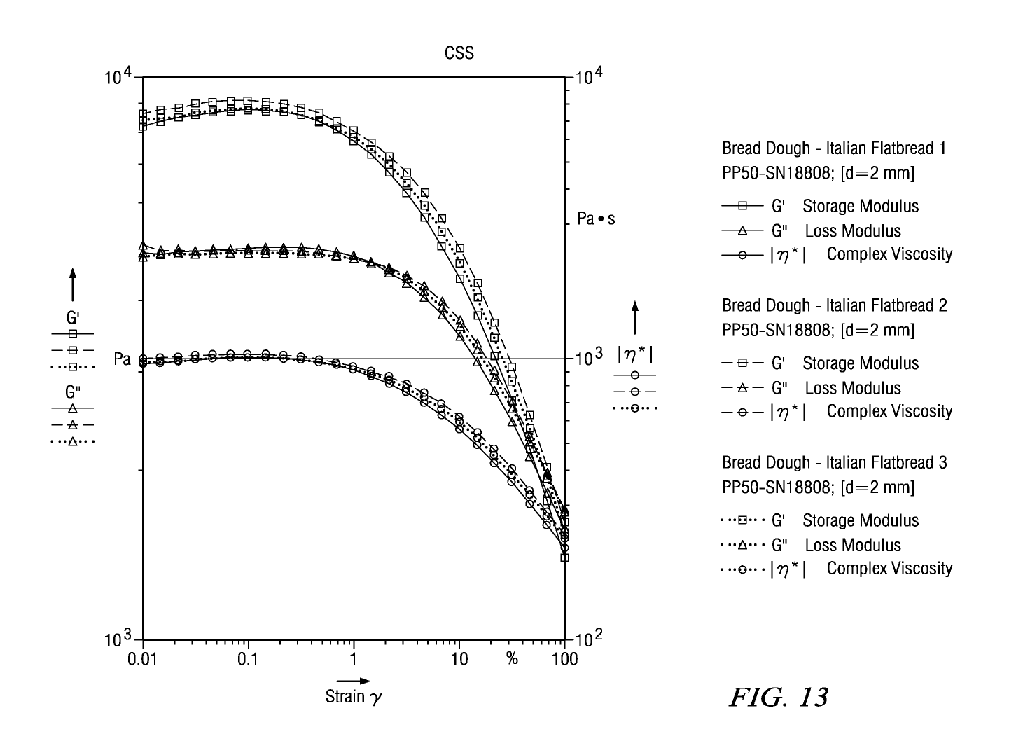

Referring to FIG. 13, the Italian crisp bread dough has significantly more elastic nature because the storage modulus (G′) values are significantly higher than the loss modulus (G″) values. Only at high strain values, above 70%, does the Italian dough have a yield point and viscous behavior becomes more dominant.

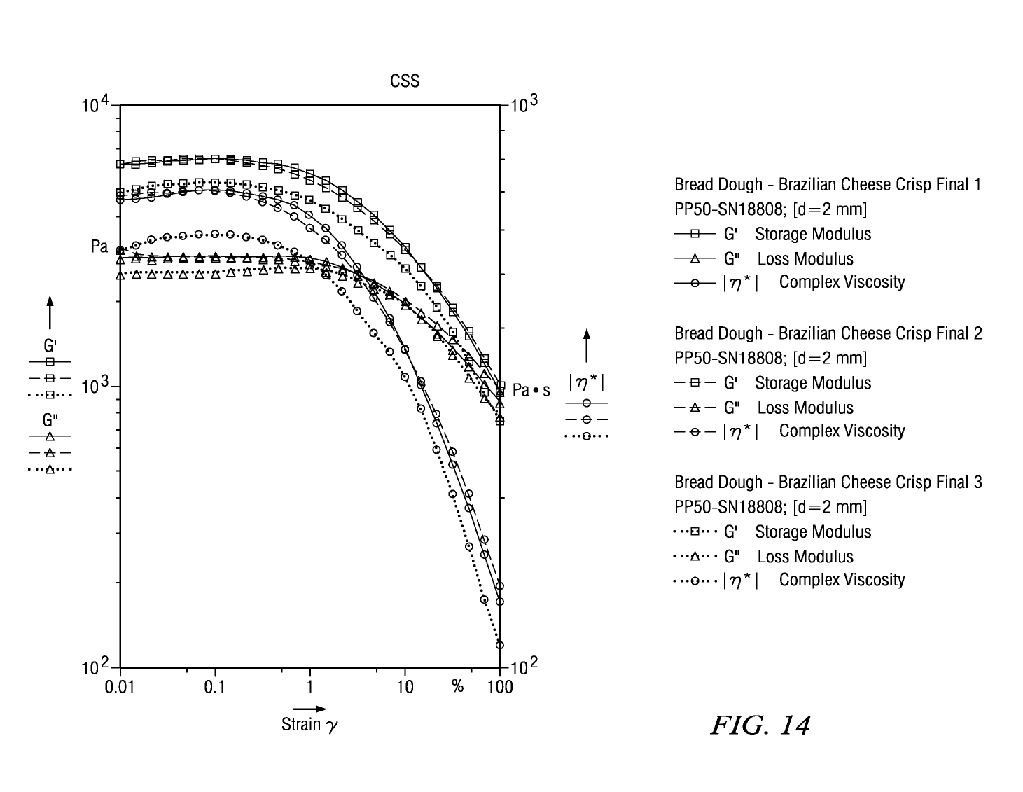

FIG. 14 shows that the Brazilian crisp bread dough demonstrates a different behavior as compared to Swedish or Italian bread dough. The Brazilian dough shows a yield point at lower strain values, about 1.5%, and viscosity decreases after the yield point. In practical terms, the Brazilian dough is softer than the Swedish or Italian bread dough.

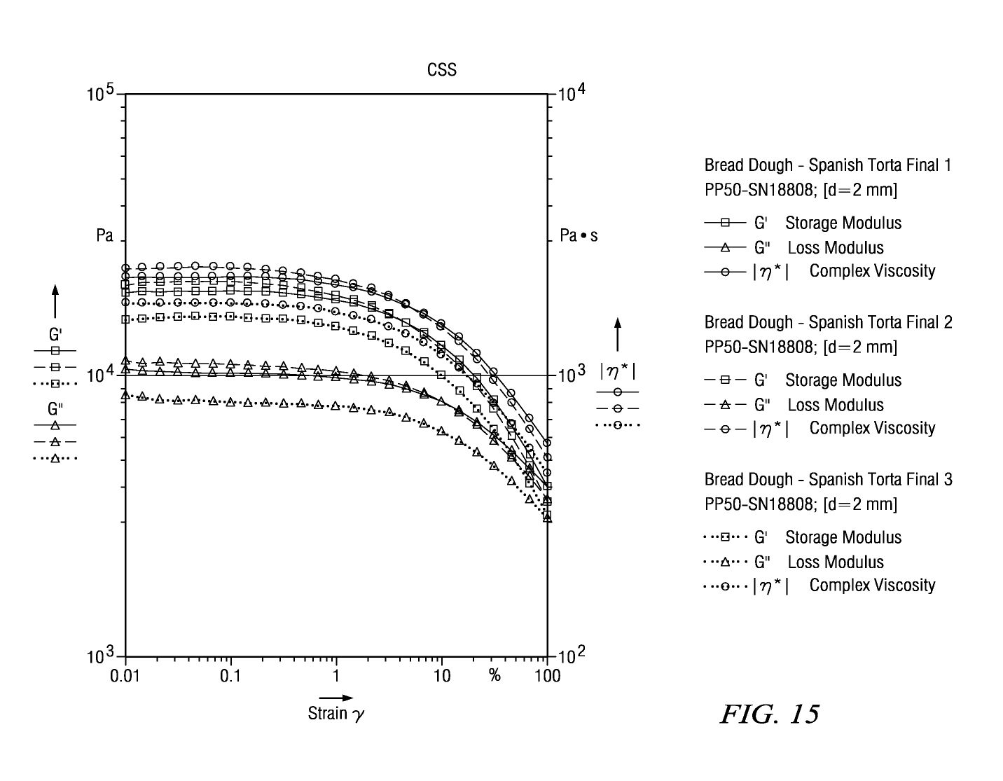

As seen in FIG. 15, the Torta crisp bread dough also demonstrates more elastic behavior at lower strain values and has higher viscosities. As the strain is increased, viscosity decreases and at only at very high strain values, above 99%, is the yield point observed.

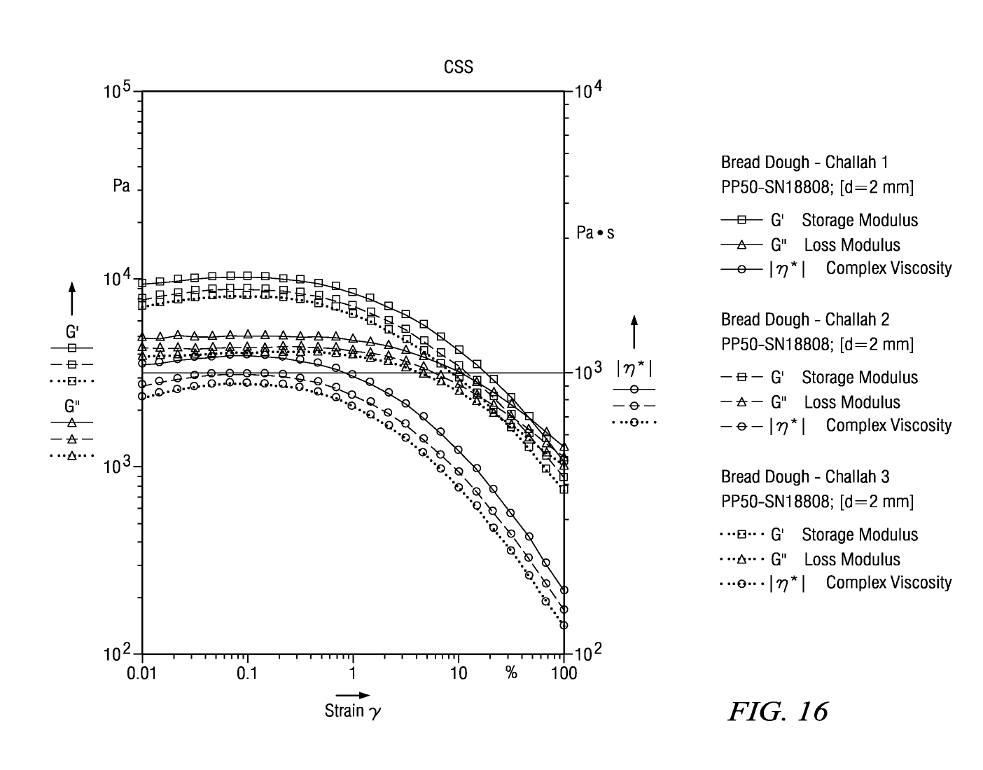

Referring to FIG. 16, the Challah crisp bread dough has a higher elastic component as compared to a viscous component at lower strain values. However, it shows a yield point at about 46% strain and beyond that point, viscous behavior is seen. In practical terms, the Challah dough will be softer and contain more air cells as compared to the Torta dough.

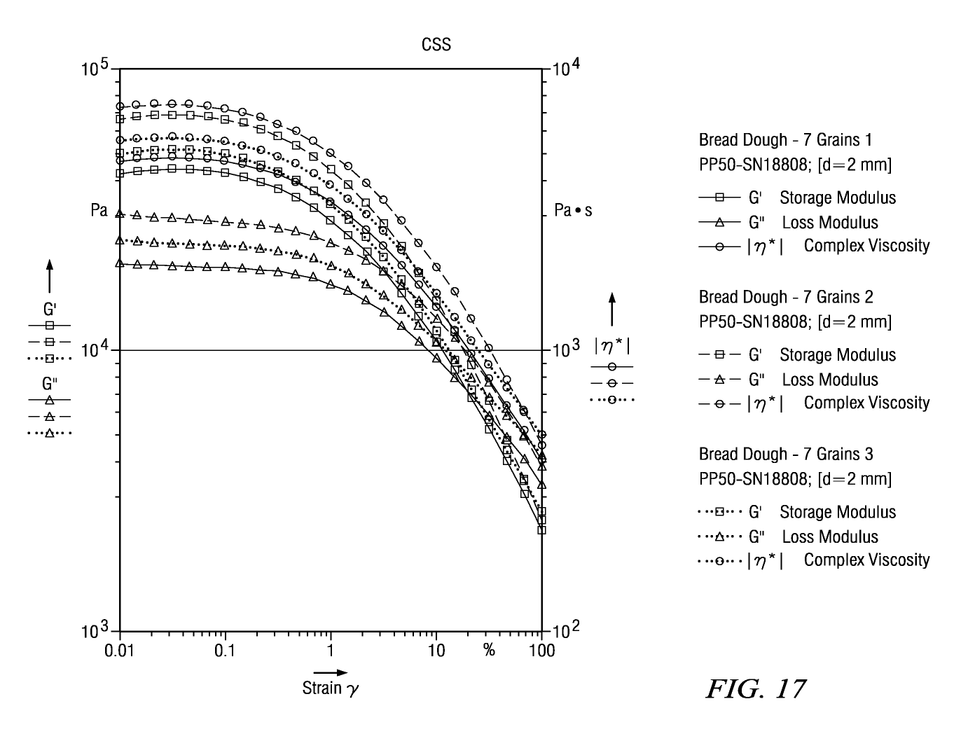

FIG. 17 shows that the Multigrain crisp bread dough also has more of an elastic nature at lower levels of strain but shows a yield point above about 20% strain. After the yield point, the viscous component increases and the complex viscosity decreases. In practical terms, the Multigrain dough will be softer than the Torta or Swedish doughs.

For comparison purposes, FIGS. 18 and 19 show the behavior of a typical cracker and bread dough. The cracker dough has a high elastic nature at lower strain levels and a yield point at above 67%. The bread dough shows an elastic behavior (gel character) as the storage modulus (G′) is greater than the loss modulus (G″). Only at higher strain values is there a yield point where the storage modulus (G′) equals the loss modulus (G″). Overall, the bread dough demonstrates a more solid than viscous behavior. Thus, the crisp bread doughs of the present invention share some characteristics with typical cracker and bread doughs but also demonstrate unique behavior.

The microstructure and breaking force, the force required to break the product, of the finished products were studied to quantify texture. There is a range of microstructures in terms of the size and number of air cells within the finished products, indicating different degrees and types of leavening and resulting in a range of textures. Air cells/voids accounted for 42%-47% of the total cross sectional area in the finished products, or 0.85-1.12 air cells per square millimeter of the product, with the average air cell area being 0.38-0.54 square millimeters. The breaking force for the crisp bread products ranges from 24 Newtons to 121 Newtons. Tables 4 and 5 disclose the microstructure and breaking force of the crisp bread products described in the Examples.

TABLE 4
Microstructure of the crisp bread
products described in the Examples.

| | Area of Cells, | No. of cells/ | Avg. cell |
|---|---|---|---|
| Product | % of total area | mm² | area, mm² |
| Swedish | 43 | 1.12 | 0.38 |
| Multigrain | 44 | 1.08 | 0.41 |
| Italian flatbread | 44 | 1.07 | 0.41 |
| Brazilian | 45 | 1.07 | 0.44 |
| Challah | 46 | 0.88 | 0.54 |
| Torta | 46 | 0.85 | 0.54 |

TABLE 5
Breaking force of the crisp bread
products described in the Examples.

| | | | Peak Force |
|---|---|---|---|
| | Peak | Std. | adjusted for |
| Product | Force, N | Dev. | thickness (N/mm) |
| Italian flatbread | 24 | 7 | 0.6 |
| Swedish | 31 | 7 | 0.5 |
| Brazilian | 56 | 27 | 1.2 |
| Torta | 64 | 18 | 1.0 |
| Multigrain | 98 | 27 | 1.4 |
| Challah | 121 | 38 | 2.3 |

While this invention has been particularly shown and described with reference to preferred embodiments, it will be understood by those skilled in the art that various changes in form and detail may be made therein without departing from the spirit and scope of the invention. All ranges herein are intended to encompass the exact ranges as well as the approximate ranges. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Additional Description

The following clauses are offered as further description of the disclosed invention.

1. A crisp bread snack food product based on a traditional bread recipe having:
a) a moisture content of between about 1.5-3.5% by weight;
b) a thickness of about 2-14 millimeters;
c) 42-47% air cells over the total area of said crisp bread snack food product; and
d) a breaking force of between about 24-121 Newtons,
wherein said crisp bread snack food product is shelf-stable, and further wherein said crisp bread snack food product comprises about 15-75% of cereal flour, about 5-25% starches or starch-rich ingredients, about 0.5-15% proteins, about 0.5-5% flavoring ingredients, about 0.5-5% leavening agents, about 0.3-3% salt, about 2-15% sugar, about 2-25% fat ingredients, and about 0.5-5% fibers.
   2. The product according to any preceding clause further having about 0.85-1.12 air cells per square millimeter of said product.
   3. The product according to any preceding clause wherein said air cells have an average area of about 0.38-0.54 square millimeters.
   4. The product according to any preceding clause wherein said cereal flour comprises wheat flour, rice flour, tapioca flour or rye flour.
   5. The product according to any preceding clause wherein said starches or starch-rich ingredients comprise precooked high-amylopectin starch or raw tapioca flour.
   6. The product according to any preceding clause wherein said proteins comprise vital wheat gluten, whole egg, egg yolk, milk powder, soy protein, egg protein or cereal proteins.
   7. The product according to any preceding clause wherein said flavoring ingredients comprise aromatic herbs, spices, extracts, fruit inclusions or vegetable inclusions.
   8. The product according to any preceding clause wherein said leavening agents comprise yeast, baking soda or baking powder.
   9. The product according to any preceding clause wherein said fat ingredients comprise butter, margarine, vegetable oil, olive oil or canola oil.
   10. The product according to any preceding clause wherein said fibers comprise a cereal grain or vegetable fiber.
   11. The product according to any preceding clause further comprising a topping or surface treatment, wherein said topping or surface treatment comprises an egg wash, nuts, seeds or dried fruits.
   12. A crisp bread snack food product based on a traditional bread recipe having:
a) a moisture content of between about 1.5-3.5% by weight;
b) a thickness of about 2-14 millimeters;
c) 42-47% air cells over the total area of said crisp bread snack food product; and
d) a breaking force of between about 24-121 Newtons,
wherein said crisp bread snack food product is shelf-stable, and further wherein the method of producing said crisp bread snack food product comprises:
   i) preparing a dough, wherein said dough comprises about 15-75% of cereal flour, about 5-25% starches or starch-rich ingredients, about 0.5-15% proteins, about 0.5-5% flavoring ingredients, about 0.5-5% leavening agents, about 0.3-3% salt, about 2-15% sugar, about 2-25% fat ingredients, and about 0.5-5% fibers;
   ii) sheeting said dough to a thickness of about 1.5-2.5 millimeters;
   iii) cutting said dough into dough pieces;
   iv) baking said dough pieces in an oven to a moisture content of about 6-25% by weight; and
   v) drying said dough pieces in a multi-pass dryer to a moisture content of about 1.5-3.5% by weight.
      13. The product according to any preceding clause further having about 0.85-1.12 air cells per square millimeter of said product.
      14. The product according to any preceding clause wherein said air cells have an average area of about 0.38-0.54 square millimeters.
      15. The product according to any preceding clause wherein step i) of said method further comprises:
a) mixing the dry ingredients; and
b) mixing the liquid ingredients with said dry ingredients.
   16. The product according to any preceding clause wherein said leavening agent comprises yeast and further wherein said yeast is activated prior to mixing said yeast with the remaining ingredients.
   17. The product according to any preceding clause wherein said method further comprises applying a surface treatment prior to step iv), wherein said surface treatment comprises an egg wash, nuts, seeds or dried fruits.
   18. The product according to any preceding clause wherein said method further comprises applying a topping after step v).
   19. The product according to any preceding clause wherein said method further comprises resting said dough prior to step ii) for up to about 60 minutes.
   20. The product according to any preceding clause wherein said oven has and a temperature of about 330-800° F. and said product exiting said oven has a moisture level of about 5-25% by weight.
   21. The product according to any preceding clause wherein said oven during baking has a heat flux of about 2-18 KW/meter square and the heat transfer coefficient of about 3-7 BTU/(hr)(ft²)(° F.).
   22. The product according to any preceding clause wherein said dough pieces are dried for about 10-25 minutes and said multi-pass dryer has a temperature of about 300-400° F.
   23. The product according to any preceding clause wherein said cereal flour comprises wheat flour, rice flour, tapioca flour or rye flour.
   24. The product according to any preceding clause wherein said starches or starch-rich ingredients comprise precooked high-amylopectin starch or raw tapioca flour.
   25. The product according to any preceding clause wherein said proteins comprise vital wheat gluten, whole egg, egg yolk, milk powder, soy protein, egg protein or cereal proteins.
   26. The product according to any preceding clause wherein said flavoring ingredients comprise aromatic herbs, spices, extracts, fruit inclusions or vegetable inclusions.
   27. The product according to any preceding clause wherein said leavening agents comprise yeast, baking soda or baking powder.
   28. The product according to any preceding clause wherein said fat ingredients comprise butter, margarine, vegetable oil, olive oil or canola oil.
   29. The product according to any preceding clause wherein said fibers comprise a cereal grain or vegetable fiber.
   30. A crisp bread snack food product based on a traditional bread recipe having:
a) a moisture content of between about 1.5-3.5% by weight;
b) a thickness of about 2-14 millimeters;
c) 42-47% air cells over the total area of said crisp bread snack food product; and
d) a breaking force of between about 24-121 Newtons,
wherein said crisp bread snack food product is shelf-stable, and further wherein said crisp bread snack food product comprises about 15-75% of cereal flour, about 5-25% starches or starch-rich ingredients, about 0.5-15% proteins, about 0.5-5% flavoring ingredients, about 0.5-5% leavening agents, about 0.3-3% salt, about 2-15% sugar, about 2-25% fat ingredients, and about 0.5-5% fibers, and further wherein the dough form of said crisp bread snack food product is characterized by:
   i) peak viscosities of about 60-800 cp, breakdown values of about 50-400 cp and setback values of about 200-800 cp when measured by a Rapid Visco Analyzer;
   ii) apparent viscosities of 26, 536-170,785 Pa at a shear rate 0.49 sec⁻¹, 10,056-54,245 Pa at a shear rate of 4.94 sec⁻¹ and 5,127-23,639 Pa at a shear rate 19.74 sec⁻¹; and
   iii) complex viscosities of 500-23,400 Pa/sec, storage modulus of 4.9×10³-2.2×10⁵ Pa, and loss modulus of 2.5×10³-1.05×10⁵ Pa.
      31. The product according to any preceding clause further having about 0.85-1.12 air cells per square millimeter of said product.
      32. The product according to any preceding clause wherein said air cells have an average area of about 0.38-0.54 square millimeters.
      33. The product according to any preceding clause wherein said cereal flour comprises wheat flour, rice flour, tapioca flour or rye flour.
      34. The product according to any preceding clause wherein said starches or starch-rich ingredients comprise precooked high-amylopectin starch or raw tapioca flour.
      35. The product according to any preceding clause wherein said proteins comprise vital wheat gluten, whole egg, egg yolk, milk powder, soy protein, egg protein or cereal proteins.
      36. The product according to any preceding clause wherein said flavoring ingredients comprise aromatic herbs, spices, extracts, fruit inclusions or vegetable inclusions.
      37. The product according to any preceding clause wherein said leavening agents comprise yeast, baking soda or baking powder.
      38. The product according to any preceding clause wherein said fat ingredients comprise butter, margarine, vegetable oil, olive oil or canola oil.
      39. The product according to any preceding clause wherein said fibers comprise a cereal grain or vegetable fiber.
      40. The product according to any preceding clause further comprising a topping or surface treatment, wherein said topping or surface treatment comprises an egg wash, nuts, seeds or dried fruits.
      41. A crisp bread snack food product based on a traditional bread recipe produced by the method comprising:
a) preparing a dough, wherein said dough comprises about 15-75% of cereal flour, about 5-25% starches or starch-rich ingredients, about 0.5-15% proteins, about 0.5-5% flavoring ingredients, about 0.5-5% leavening agents, about 0.3-3% salt, about 2-15% sugar, about 2-25% fat ingredients, and about 0.5-5% fibers;
b) sheeting said dough to a thickness of about 1.5-2.5 millimeters;
c) cutting said dough into dough pieces;
d) baking said dough pieces in an oven to a moisture content of about 6-25% by weight; and
e) drying said dough pieces in a multi-pass dryer to a moisture content of about 1.5-3.0% by weight;
wherein said crisp bread snack food product is shelf-stable, and further wherein said dough is characterized by:
   i) peak viscosities of about 60-800 cp, breakdown values of about 50-400 cp and setback values of about 200-800 cp when measured by a Rapid Visco Analyzer;
   ii) apparent viscosities of 26, 536-170,785 Pa at a shear rate 0.49 sec⁻¹, 10,056-54,245 Pa at a shear rate of 4.94 sec⁻¹ and 5,127-23,639 Pa at a shear rate 19.74 sec⁻¹; and
   iii) complex viscosities of 500-23,400 Pa/sec, storage modulus of 4.9×10³-2.2×10⁵ Pa, and loss modulus of 2.5×10³-1.05×10⁵ Pa.
      42. The product according to any preceding clause wherein step a) of said method further comprises:
a) mixing the dry ingredients; and
b) mixing the liquid ingredients with said dry ingredients.
   43. The product according to any preceding clause wherein said leavening agent comprises yeast and further wherein said yeast is activated prior to mixing said yeast with the remaining ingredients.
   44. The product according to any preceding clause wherein said method further comprises applying a surface treatment prior to step d), wherein said surface treatment comprises an egg wash, nuts, seeds or dried fruits.
   45. The product according to any preceding clause wherein said method further comprises applying a topping after step e).
   46. The product according to any preceding clause wherein said method further comprises resting said dough prior to step ii) up to about 60 minutes.
   47. The product according to any preceding clause wherein said oven has and a temperature of about 330-800° F. and said product exiting said oven has a moisture level of about 5-25% by weight.
   48. The product according to any preceding clause wherein said oven during baking has a heat flux of about 2-18 KW/meter square and the heat transfer coefficient of about 3-7 BTU/(hr)(ft²)(° F.).
   49. The product according to any preceding clause wherein said dough pieces are dried for about 10-25 minutes and said multi-pass dryer has a temperature of about 300-500° F.
   50. The product according to any preceding clause wherein said cereal flour comprises wheat flour, rice flour, tapioca flour or rye flour.
   51. The product according to any preceding clause wherein said starches or starch-rich ingredients comprise precooked high-amylopectin starch or raw tapioca flour.
   52. The product according to any preceding clause wherein said proteins comprise vital wheat gluten, whole egg, egg yolk, milk powder, soy protein, egg protein or cereal proteins.
   53. The product according to any preceding clause wherein said flavoring ingredients comprise aromatic herbs, spices, extracts, fruit inclusions or vegetable inclusions.
   54. The product according to any preceding clause wherein said leavening agents comprise yeast, baking soda or baking powder.
   55. The product according to any preceding clause wherein said fat ingredients comprise butter, margarine, vegetable oil, olive oil or canola oil.
   56. The product according to any preceding clause wherein said fibers comprise a cereal grain or vegetable fiber.

We claim:

1. A crisp bread snack food product based on a traditional bread recipe having:
a) a moisture content of between about 1.5-3.5% by weight;
b) a thickness of about 2-14 millimeters;
c) 42-47% air cells over the total area of said crisp bread snack food product; and
d) a breaking force of between about 24-121 Newtons,
wherein said crisp bread snack food product is shelf-stable, and further wherein said crisp bread snack food product comprises about 15-75% of cereal flour, about 5-25% starches or starch-rich ingredients, about 0.5-15% proteins, about 0.5-5% flavoring ingredients, about 0.5-5% leavening agents, about 0.3-3% salt, about 2-15% sugar, about 2-25% fat ingredients, and about 0.5-5% fibers.

2. The product of claim 1 further having about 0.85-1.12 air cells per square millimeter of said product.

3. The product of claim 1 wherein said air cells have an average area of about 0.38-0.54 square millimeters.

4. The product of claim 1 wherein said cereal flour comprises wheat flour, rice flour, tapioca flour or rye flour.

5. The product of claim 1 wherein said starches or starch-rich ingredients comprise precooked high-amylopectin starch or raw tapioca flour.

6. The product of claim 1 wherein said proteins comprise vital wheat gluten, whole egg, egg yolk, milk powder, soy protein, egg protein or cereal proteins.

7. The product of claim 1 wherein said flavoring ingredients comprise aromatic herbs, spices, extracts, fruit inclusions or vegetable inclusions.

8. The product of claim 1 wherein said leavening agents comprise yeast, baking soda or baking powder.

9. The product of claim 1 wherein said fat ingredients comprise butter, margarine, vegetable oil, olive oil or canola oil.

10. The product of claim 1 wherein said fibers comprise a cereal grain or vegetable fiber.

11. The product of claim 1 further comprising a topping or surface treatment, wherein said topping or surface treatment comprises an egg wash, nuts, seeds or dried fruits.

12. A crisp bread snack food product based on a traditional bread recipe having:
a) a moisture content of between about 1.5-3.5% by weight;
b) a thickness of about 2-14 millimeters;
c) 42-47% air cells over the total area of said crisp bread snack food product; and
d) a breaking force of between about 24-121 Newtons,
wherein said crisp bread snack food product is shelf-stable, and further wherein the method of producing said crisp bread snack food product comprises:
i) preparing a dough, wherein said dough comprises about 15-75% of cereal flour, about 5-25% starches or starch-rich ingredients, about 0.5-15% proteins, about 0.5-5% flavoring ingredients, about 0.5-5% leavening agents, about 0.3-3% salt, about 2-15% sugar, about 2-25% fat ingredients, and about 0.5-5% fibers;
ii) sheeting said dough to a thickness of about 1.5-2.5 millimeters;
iii) cutting said dough into dough pieces;
iv) baking said dough pieces in an oven to a moisture content of about 6-25% by weight; and
v) drying said dough pieces in a multi-pass dryer to a moisture content of about 1.5-3.5% by weight.

13. The product of claim 12 further having about 0.85-1.12 air cells per square millimeter of said product.

14. The product of claim 12 wherein said air cells have an average area of about 0.38-0.54 square millimeters.

15. The product of claim 12 wherein step i) of said method further comprises:
a) mixing the dry ingredients; and
b) mixing the liquid ingredients with said dry ingredients.

16. The product of claim 12 wherein said leavening agent comprises yeast and further wherein said yeast is activated prior to mixing said yeast with the remaining ingredients.

17. The product of claim 12 wherein said method further comprises applying a surface treatment prior to step iv), wherein said surface treatment comprises an egg wash, nuts, seeds or dried fruits.

18. The product of claim 12 wherein said method further comprises applying a topping after step v).

19. The product of claim 12 wherein said method further comprises resting said dough prior to step ii) for up to about 60 minutes.

20. The product of claim 12 wherein said oven has and a temperature of about 330-800° F. and said product exiting said oven has a moisture level of about 5-25% by weight.

21. The product of claim 12 wherein said oven during baking has a heat flux of about 2-18 KW/meter square and the heat transfer coefficient of about 3-7 BTU/(hr)(ft²)(° F.).

22. The product of claim 12 wherein said dough pieces are dried for about 10-25 minutes and said multi-pass dryer has a temperature of about 300-400° F.

23. The product of claim 12 wherein said cereal flour comprises wheat flour, rice flour, tapioca flour or rye flour.

24. The product of claim 12 wherein said starches or starch-rich ingredients comprise precooked high-amylopectin starch or raw tapioca flour.

25. The product of claim 12 wherein said proteins comprise vital wheat gluten, whole egg, egg yolk, milk powder, soy protein, egg protein or cereal proteins.

26. The product of claim 12 wherein said flavoring ingredients comprise aromatic herbs, spices, extracts, fruit inclusions or vegetable inclusions.

27. The product of claim 12 wherein said leavening agents comprise yeast, baking soda or baking powder.

28. The product of claim 12 wherein said fat ingredients comprise butter, margarine, vegetable oil, olive oil or canola oil.

29. The product of claim 12 wherein said fibers comprise a cereal grain or vegetable fiber.

30. A crisp bread snack food product based on a traditional bread recipe having:
a) a moisture content of between about 1.5-3.5% by weight;
b) a thickness of about 2-14 millimeters;
c) 42-47% air cells over the total area of said crisp bread snack food product; and
d) a breaking force of between about 24-121 Newtons,
wherein said crisp bread snack food product is shelf-stable, and further wherein said crisp bread snack food product comprises about 15-75% of cereal flour, about 5-25% starches or starch-rich ingredients, about 0.5-15% proteins, about 0.5-5% flavoring ingredients, about 0.5-5% leavening agents, about 0.3-3% salt, about 2-15% sugar, about 2-25% fat ingredients, and about 0.5-5% fibers, and further wherein the dough form of said crisp bread snack food product is characterized by:
i) peak viscosities of about 60-800 cp, breakdown values of about 50-400 cp and setback values of about 200-800 cp when measured by a Rapid Visco Analyzer;
ii) apparent viscosities of 26, 536-170,785 Pa at a shear rate 0.49 sec⁻¹, 10,056-54,245 Pa at a shear rate of 4.94 sec⁻¹ and 5,127-23,639 Pa at a shear rate 19.74 sec⁻¹; and
iii) complex viscosities of 500-23,400 Pa/sec, storage modulus of 4.9×10³-2.2×10⁵ Pa, and loss modulus of 2.5×10³-1.05×10⁵ Pa.

31. The product of claim 30 further having about 0.85-1.12 air cells per square millimeter of said product.

32. The product of claim 30 wherein said air cells have an average area of about 0.38-0.54 square millimeters.

33. The product of claim 30 wherein said cereal flour comprises wheat flour, rice flour, tapioca flour or rye flour.

34. The product of claim 30 wherein said starches or starch-rich ingredients comprise precooked high-amylopectin starch or raw tapioca flour.

35. The product of claim 30 wherein said proteins comprise vital wheat gluten, whole egg, egg yolk, milk powder, soy protein, egg protein or cereal proteins.

36. The product of claim 30 wherein said flavoring ingredients comprise aromatic herbs, spices, extracts, fruit inclusions or vegetable inclusions.

37. The product of claim 30 wherein said leavening agents comprise yeast, baking soda or baking powder.

38. The product of claim 30 wherein said fat ingredients comprise butter, margarine, vegetable oil, olive oil or canola oil.

39. The product of claim 30 wherein said fibers comprise a cereal grain or vegetable fiber.

40. The product of claim 30 further comprising a topping or surface treatment, wherein said topping or surface treatment comprises an egg wash, nuts, seeds or dried fruits.

41. A crisp bread snack food product based on a traditional bread recipe produced by the method comprising:
a) preparing a dough, wherein said dough comprises about 15-75% of cereal flour, about 5-25% starches or starch-rich ingredients, about 0.5-15% proteins, about 0.5-5% flavoring ingredients, about 0.5-5% leavening agents, about 0.3-3% salt, about 2-15% sugar, about 2-25% fat ingredients, and about 0.5-5% fibers;
b) sheeting said dough to a thickness of about 1.5-2.5 millimeters;
c) cutting said dough into dough pieces;
d) baking said dough pieces in an oven to a moisture content of about 6-25% by weight; and
e) drying said dough pieces in a multi-pass dryer to a moisture content of about 1.5-3.0% by weight;
wherein said crisp bread snack food product is shelf-stable, and further wherein said dough is characterized by:
i) peak viscosities of about 60-800 cp, breakdown values of about 50-400 cp and setback values of about 200-800 cp when measured by a Rapid Visco Analyzer;
ii) apparent viscosities of 26, 536-170,785 Pa at a shear rate 0.49 sec⁻¹, 10,056-54,245 Pa at a shear rate of 4.94 sec⁻¹ and 5,127-23,639 Pa at a shear rate 19.74 sec⁻¹; and
iii) complex viscosities of 500-23,400 Pa/sec, storage modulus of 4.9×10³-2.2×10⁵ Pa, and loss modulus of 2.5×10³-1.05×10⁵ Pa.

42. The product of claim 41 wherein step a) of said method further comprises:
a) mixing the dry ingredients; and
b) mixing the liquid ingredients with said dry ingredients.

43. The product of claim 41 wherein said leavening agent comprises yeast and further wherein said yeast is activated prior to mixing said yeast with the remaining ingredients.

44. The product of claim 41 wherein said method further comprises applying a surface treatment prior to step d), wherein said surface treatment comprises an egg wash, nuts, seeds or dried fruits.

45. The product of claim 41 wherein said method further comprises applying a topping after step e).

46. The product of claim 41 wherein said method further comprises resting said dough prior to step ii) up to about 60 minutes.

47. The product of claim 41 wherein said oven has and a temperature of about 330-800° F. and said product exiting said oven has a moisture level of about 5-25% by weight.

48. The product of claim 41 wherein said oven during baking has a heat flux of about 2-18 KW/meter square and the heat transfer coefficient of about 3-7 BTU/(hr)(ft²)(° F.).

49. The product of claim 41 wherein said dough pieces are dried for about 10-25 minutes and said multi-pass dryer has a temperature of about 300-500° F.

50. The product of claim 41 wherein said cereal flour comprises wheat flour, rice flour, tapioca flour or rye flour.

51. The product of claim 41 wherein said starches or starch-rich ingredients comprise precooked high-amylopectin starch or raw tapioca flour.

52. The product of claim 41 wherein said proteins comprise vital wheat gluten, whole egg, egg yolk, milk powder, soy protein, egg protein or cereal proteins.

53. The product of claim 41 wherein said flavoring ingredients comprise aromatic herbs, spices, extracts, fruit inclusions or vegetable inclusions.

54. The product of claim 41 wherein said leavening agents comprise yeast, baking soda or baking powder.

55. The product of claim 41 wherein said fat ingredients comprise butter, margarine, vegetable oil, olive oil or canola oil.

56. The product of claim 41 wherein said fibers comprise a cereal grain or vegetable fiber.
